(19) United States
(12) Patent Application Publication
(10) Pub. No.: US 2017/0044076 A1
(43) Pub. Date: Feb. 16, 2017

(54) SOIL NEUTRALIZATION PRODUCT AND METHOD OF MAKING SAME

(71) Applicant: John Hinton Waters, Chatsworth, GA (US)

(72) Inventor: John Hinton Waters, Chatsworth, GA (US)

(21) Appl. No.: 14/826,353

(22) Filed: Aug. 14, 2015

(51) Int. Cl. C05D 3/02; C05G 3/04; C05G 3/00; C05D 5/00

(52) U.S. Cl. CPC C05D 3/02; C05D 5/00; C05G 3/04; C05G 3/0058

(57) ABSTRACT

A process for making an agricultural lime product utilizes recycled carpet mineral filler material. Used carpet undergoes a shredding process separating valuable resin fibers from the mineral filler and the residual glue. The mineral filler/residual glue undergoes a screening process and then a pelletizing process to produce an agricultural lime product. A liquid or dry adhesive binder can be added to facilitate compaction of the mineral filler in such a manner as to form a pellet, which reduces dust and increases the ease of handling.

### TECHNICAL FIELD AND BACKGROUND OF INVENTION

The present invention relates to a soil neutralization product, such as agricultural lime, and a process for making the product. An embodiment of the invention comprises a process in which carpet filler is recycled and used to produce an agricultural lime product for use in soil neutralization.

The recycling of used carpet is common today. Typically, the recycling of used carpet involves shredding the used carpet into pieces and separating reusable carpet fibers from the carpet adhesive and adhesive components, such as filler material. The adhesive material generated from carpet recycling has generally had minimal economic value and is therefore disposed of as waste, typically by being land filled.

Disposing the adhesive material in landfills can be economically and environmentally costly. Accordingly, it would be desirable to adapt the adhesive material for a productive use having the potential to generate economic value from the adhesive material rather than having to incur the costs of land filling the material. Calcium carbonate and magnesium carbonate are commonly used as filler materials in carpet adhesives. These materials are also components of agricultural lime products used for soil neutralization. However, current carpet recycling methods typically reduce these adhesive filler materials to a fine powder that is unsuitable for use in agricultural lime products.

### SUMMARY OF INVENTION

Accordingly, one object of the present invention is to provide a process in which adhesive material generated from the recycling of used carpet is adapted for an economically beneficial application. Another object of the present invention is to provide a method in which carpet adhesive filler material from recycled used carpet is adapted for use as an agricultural lime product for soil neutralization. These and other objects of the invention can be achieved in various embodiments of the invention described below.

A method of making a soil neutralization pellet according to an embodiment of the invention comprises providing a waste powder generated from recycled used carpet, and compressing the waste powder with a binding agent adapted for facilitating compression of the waste powder into pellets adapted for use in soil neutralization.

According to another embodiment of the invention, the waste powder comprises calcium carbonate and/or magnesium carbonate.

According to another embodiment of the invention, the waste powder comprises an adhesive.

According to another embodiment of the invention, the adhesive comprises a mineral filler comprised of calcium carbonate or magnesium carbonate.

According to another embodiment of the invention, the waste powder comprises latex.

According to another embodiment of the invention, the used carpet is shredded and separated into a first mixture comprising the waste powder and a second mixture comprising reusable carpet fibers.

According to another embodiment of the invention, the waste powder comprises an adhesive and an adhesive filler material from the used carpet. The adhesive filler material comprises calcium carbonate and/or magnesium carbonate.

According to another embodiment of the invention, the binding agent is water, lignum, paraffin wax, polypropylene, acrylic, and/or polyethylene.

According to another embodiment of the invention, the pellets have a size of −½ inch to +50 mesh.

A method of making an agricultural lime pellet for use in soil neutralization according to an embodiment of the invention comprises providing a used carpet material comprising reusable carpet fibers, adhesive and adhesive filler material, shredding the used carpet material, and separating the used carpet material into a first mixture comprising the reusable carpet fibers and a second mixture comprising a waste powder comprising the adhesive and the adhesive filler material. The waste powder is compressed into pellets to produce a pelletized agricultural lime product adapted for use in soil neutralization.

According to another embodiment of the invention, the pellets have a size of −½ inch to +50 mesh.

According to another embodiment of the invention, the waste powder is mixed with a binding agent adapted for facilitating compression of the waste powder into pellets to produce a pelletized agricultural lime product adapted for use in soil neutralization.

According to another embodiment of the invention, the waste powder is positioned on a rotating disc while the binding agent is applied to the waste powder on the rotating disc, such that the waste powder is formed into the pelletized agricultural lime product. The binding agent can be water, lignum, paraffin wax, polypropylene, acrylic, or polyethylene.

According to another embodiment of the invention, the waste powder is positioned between two rollers that compact the waste powder into the pelletized agricultural lime product.

Another embodiment of the invention comprises an agricultural lime pellet for use in soil neutralization made by a process in which used carpet material is shredded and reusable carpet fibers are separated from the carpet adhesive material. The separated adhesive material is compressed into an agricultural lime pellet adapted for use in soil neutralization.

According to another embodiment of the invention, the pellet comprises calcium carbonate, and has a size of −½ inch to +50 mesh.

Another embodiment of the invention comprises a process that compacts/compresses/densifies/pelletizes the loose adhesive waste powders derived from the shredding and separation process of used carpet to produce a usable pelletized product with drastically reduced fugitive dust emissions, allows much easier handling and broadcast characteristics are greatly improved.

### BRIEF DESCRIPTION OF THE DRAWINGS

FIG. 1 is a schematic flow diagram illustrating a process for making an agricultural lime product according to a preferred embodiment; and

FIG. 2 is a perspective view of soil neutralization pellets according to a preferred embodiment of the invention.

Description of Preferred Embodiments of the Invention and Best Mode

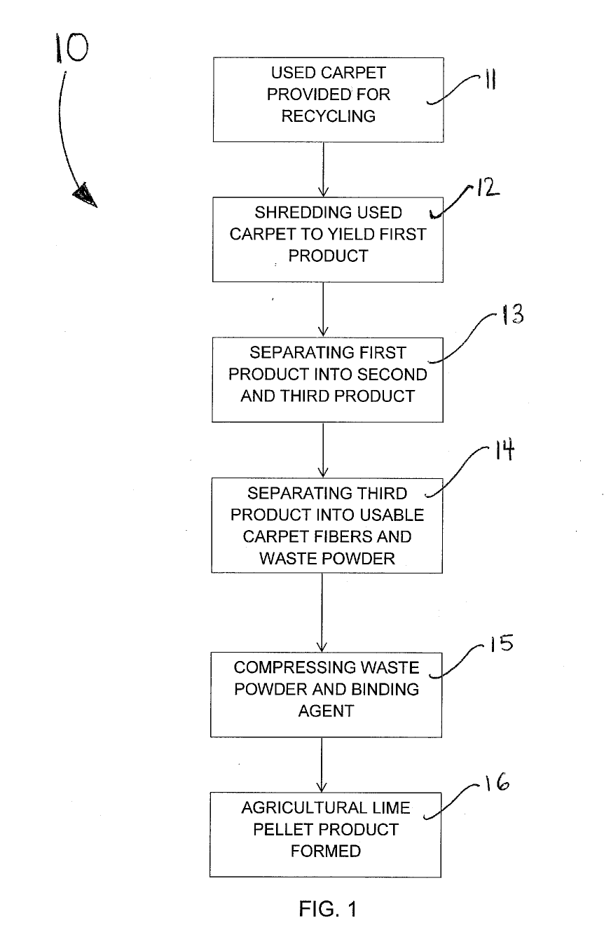

A process for making a soil neutralization product according to a preferred embodiment of the invention is illustrated in FIG. 1, and shown generally at reference numeral 10. The process comprises adapting adhesive material generated from recycled used carpet to produce a pelletized agricultural lime product for use in soil neutralization.

In the first step, shown at reference numeral 11 of FIG. 1, used carpet material that is to be recycled is provided. The used carpet material can be generally comprised of carpet fibers and adhesive material. The carpet adhesive material can be comprised of an adhesive and a mineral filler material, such as calcium carbonate (CaCO₃) or magnesium carbonate (MgCO₃). In addition, the adhesive material can include organic filler material. Typically, the organic filler will constitute 15%-35 of the adhesive material.

The second step 12 comprises shredding the used carpet material to yield a first product comprised of shredded carpet material. The third step 13 comprises separating the shredded carpet material into a second product comprised of reusable carpet fibers and a third product comprised of adhesive material and residual carpet fibers. That is, reusable carpet fibers are separated from the adhesive material comprising adhesive and adhesive filler material. If desired, the adhesive material can undergo a second separation process in a fourth step 14 of the process 10 to further separate and remove residual carpet fibers from the adhesive material. The shredding and separating steps 12, 13, 14 can be carried out via known carpet recycling methods, such as is described in U.S. Patent Application Publication 2011/0040027, which is incorporated herein by reference. For example, the separation steps 13, 14 can be carried out using screening, gravity separation, air classification, or any combination thereof. The shredding and separating steps 12, 13, 14 render the adhesive material into a loose, free flowing waste powder having a size of approximately −20 mesh to +100 mesh. That is, ninety percent or more of the waste powder particles can pass through a 20 mesh sieve and is retained by a 100 mesh sieve.

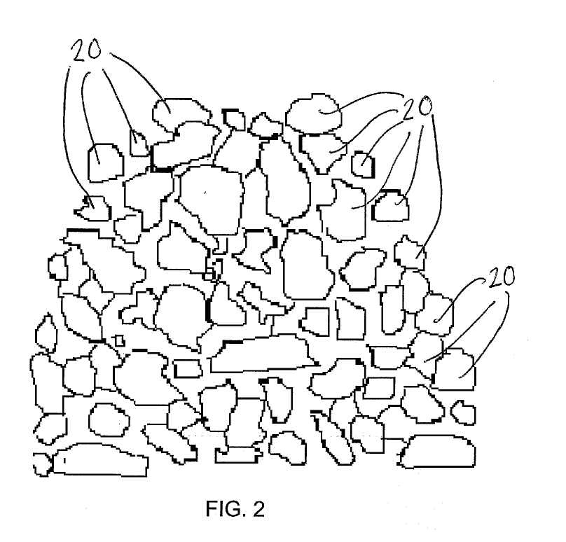

In a fifth step 15, the adhesive material waste powder is mixed compressed into larger pellets 20, shown in FIG. 2, that are suitable for use as agricultural lime. A binding aid can be added to the waste powder during the compression step 15. The binding aid facilitates the compression of the waste powder, and helps bind the powders together to prevent the compacted powder from returning to the original powder state. The binding aid can be a liquid or solid substance that holds the compacted powder together in a longer lasting state. Liquid binding aids include water and lignum. Solid binding aids include wax, various resins, polypropylene, acrylic, and polyethylene. Preferably, the binding aid is added to and mixed with the waste powder such that the binding aid is 5%-25% of the total weight of the waste powder and binding aid mixture.

The compression step 15 can be carried out by a variety of means for compressing the powder together. The adhesive material waste powder can be compressed by moving the powder particles between two rollers which compact the waste powder particles into larger pellets. Alternatively, the waste powder is moved over a rotating disc while a liquid binding aid is applied to the waste powder moving on the rotating disc, causing the waste powders to lump together and form pellets. Alternatively, the compression step 15 can be carried out by other means such as extrusion. Optionally, the pellets formed by compression step can then be screened to a specific particle size to meet a set specification or can be used directly as is.

The adhesive material waste powder is compressed into pellets 20 in which 98% of the pellets 20 have a size of −½ inch to +50 mesh. That is, 98% or more of the pellets 20 can pass through a ½ inch sieve and is retained by a 50 mesh screen. The compressed pellets 20 reduce dust and increases the ease of handling. The carpet mineral filler (calcium carbonate (CaCO₃) or magnesium carbonate (MgCO₃)) contained in the pellets 20 has pH neutralizing properties. In addition, the organic compounds contained in the pellets 20 provide improved moisture retention and anti-caking properties, which are valuable soil improvement properties. As such, the pellets 20 have the chemical and physical properties suitable for use as an agricultural lime soil neutralization product.

At the end 16 of the process 10 an agricultural lime pellet 20 is formed. The process 10 produces a pelletized product 20 with drastically reduced fugitive dust emissions, allows much easier handling and broadcast characteristics are greatly improved. The process 10 produces a valuable soil improvement product 20 which provides pH neutralization, water retention, anti-caking, reduced fugitive dust and drastically improved handling and broadcast characteristics all of which produces a useable pelletized product that would otherwise be land filled.

An soil neutralization product and method of making same are described above. Various changes can be made to the invention without departing from its scope. The above description of the preferred embodiments and best mode of the invention are provided for the purpose of illustration only and not limitation—the invention being defined by the following claims and equivalents thereof.

What is claimed is:

1. A method of making a soil neutralization pellet comprising:
(a) providing a waste powder generated from recycled used carpet; and
(b) compressing the waste powder with a binding agent adapted for facilitating compression of the waste powder into pellets adapted for use in soil neutralization.

2. The method of claim 1, wherein the waste powder comprises at least one compound selected from the group consisting of calcium carbonate and magnesium carbonate.

3. The method of claim 1, wherein the waste powder comprises an adhesive.

4. The method of claim 3, wherein the adhesive comprises a mineral filler comprising at least one compound selected from the group consisting of calcium carbonate and magnesium carbonate.

5. The method of claim 4, wherein the waste powder further comprises latex.

6. The method of claim 1, wherein providing a waste powder generated from recycled used carpet comprises shredding used carpet and separating the shredded used carpet into a first mixture comprising the waste powder and a second mixture comprising reusable carpet fibers.

7. The method of claim 6, wherein the waste powder comprises an adhesive and an adhesive filler material from the used carpet.

8. The method of claim 7, wherein the adhesive filler material comprises at least one compound selected from the group consisting of calcium carbonate and magnesium carbonate.

9. The method of claim 1, wherein the binding agent comprises at least one selected from the group consisting of water, lignum, paraffin wax, polypropylene, acrylic, and polyethylene.

10. The method of claim 1, wherein the pellets have a size of −½ inch to +50 mesh.

11. A method of making an agricultural lime pellet for use in soil neutralization comprising:
(a) providing a used carpet material comprising reusable carpet fibers, adhesive and adhesive filler material;
(b) shredding the used carpet material;
(c) separating the used carpet material into a first mixture comprising the reusable carpet fibers and a second mixture comprising a waste powder comprising the adhesive and the adhesive filler material;
(d) compressing the waste powder into pellets to produce a pelletized agricultural lime product adapted for use in soil neutralization.

12. The method of claim 11, wherein the pellets have a size of ½ inch to +50 mesh.

13. The method of claim 11, wherein the step of compressing the waste powder into pellets comprises mixing the waste powder with a binding agent adapted for facilitating compression of the waste powder into pellets to produce a pelletized agricultural lime product adapted for use in soil neutralization.

14. The method of claim 13, wherein the step of compressing the waste powder further comprises moving the waste powder over a rotating disc while the binding agent is applied to the waste powder moving on the rotating disc, whereby the waste powder is formed into the pelletized agricultural lime product.

15. The method of claim 13, wherein the binding agent comprises at least one selected from the group consisting of water, lignum, paraffin wax, polypropylene, acrylic, and polyethylene.

16. The method of claim 11, wherein the step of compressing the waste powder into pellets comprises moving the waste powder between two rollers that compact the waste powder into the pelletized agricultural lime product.

17. The method of claim 11, wherein the adhesive filler material comprises calcium carbonate.

18. An agricultural lime pellet for use in soil neutralization made by a process comprising:
(a) providing a used carpet material comprising reusable carpet fibers and an adhesive material, the adhesive material comprising a mineral filler;
(b) shredding the used carpet material and separating the reusable fibers from the adhesive material; and
(c) compressing the adhesive material into an agricultural lime pellet adapted for use in soil neutralization.

19. The agricultural lime pellet according to claim 18, wherein the mineral filler comprises calcium carbonate.

20. The agricultural lime pellet according to claim 18, wherein the pellet has a size of −½ inch to +50 mesh.
